(19) United States
(12) Patent Application Publication
(10) Pub. No.: US 2026/0261474 A1
(43) Pub. Date: Sep. 3, 2026

(54) EVENT INFORMATION GENERATING DEVICE, EVENT INFORMATION GENERATING METHOD, AND EVENT INFORMATION GENERATING PROGRAM

(71) Applicant: NTT, Inc., Tokyo (JP)

(72) Inventors: Di LI, Musashino-shi, Tokyo (JP); Haruhisa NOZUE, Musashino-shi, Tokyo (JP); Norio YAMAMOTO, Musashino-shi, Tokyo (JP)

(21) Appl. No.: 18/871,581

(22) PCT Filed: Jun. 13, 2022
(86) PCT No.: PCT/JP2022/023636

§ 371 Date: Dec. 4, 2024

(51) Int. Cl. H04L 41/0677; H04L 41/0631; H04L 41/0686

(52) U.S. Cl. CPC H04L 41/0677; H04L 41/065; H04L 41/0686

(57) ABSTRACT

An event information generation device includes a grouping unit that performs clustering and grouping on alarm information of the target network environment and alarm information of an existing similar network environment similar to the target network environment to generate clusters having dissimilar shapes but having the same meaning, and an event conversion unit that converts existing event information of the existing similar network environment by using the clusters having dissimilar shapes but having the same meaning, which are generated by the grouping unit, to generate the new event information.

### TECHNICAL FIELD

The present invention relates to an event information generation device, an event information generation method, and an event information generation program.

### BACKGROUND ART

In order to maintain the reliability of a network, it is necessary to estimate the location of a failure after the occurrence of a network failure and to rapidly perform recovery work. As a method of estimating a failure location in a network, there is a method using a rule created from past experiences based on an event occurring due to a failure.

### CITATION LIST

### Patent Literature

[PTL 1] Japanese Patent Application Publication No. 2018-28778

### SUMMARY OF INVENTION

### Technical Problem

In the above-described method, it is necessary for a maintenance person to compare a determination result obtained by performing determination using the rule with a failure correspondence result which is the true cause, and to determine whether the determination result is correct. For this reason, it takes a long time to create a rule for estimating a failure location including determination of an event and a corresponding method.

The present invention has been made by paying attention to the above circumstances, and an object thereof is to provide an event information generation device, an event information generation method, and an event information generation program for generating event information for creating a rule for failure location estimation in a short period of time.

### Solution to Problem

One aspect of the present invention is an event information generation device that generates new event information to be applied to a rule for failure location estimation of a target network environment. The event information generation device includes a grouping unit configured to perform clustering and grouping on alarm information of the target network environment and alarm information of an existing similar network environment similar to the target network environment to generate clusters having dissimilar shapes but having the same meaning, and an event conversion unit configured to convert existing event information of the existing similar network environment by using the clusters having dissimilar shapes but having the same meaning, which are generated by the grouping unit, to generate the new event information.

One aspect of the present invention is an event information generation method of generating new event information to be applied to a rule for failure location estimation of a target network environment. The event information generation method includes performing clustering and grouping on alarm information of the target network environment and alarm information of an existing similar network environment similar to the target network environment to generate clusters having dissimilar shapes but having the same meaning, and converting existing event information of the existing similar network environment by using the generated clusters having dissimilar shapes but having the same meaning to generate the new event information.

One aspect of the present invention is an event information generation program. The event information generation program causes a processor included in the event information generation device to execute processing of the grouping unit and the event conversion unit of the event information generation device.

### Advantageous Effects of Invention

According to the present invention, there are provided an event information generation device, an event information generation method, and an event information generation program for generating event information for creating a rule for failure location estimation in a short period of time.

### BRIEF DESCRIPTION OF DRAWINGS

FIG. 1 is a block diagram showing an example of a hardware configuration of an event information generation device according to an embodiment.

FIG. 2 is a block diagram showing an example of a software configuration of the event information generation device according to the embodiment.

FIG. 3 is a diagram showing a flow of data in the event information generation device shown in FIG. 2, and a flow of information between the event information generation device, an existing similar network environment, and a target network environment.

FIG. 4 is a flowchart showing a processing procedure and a processing content of the event information generation device shown in FIG. 2.

FIG. 5 is a diagram schematically showing a transition of learned event information in an operation example of the event information generation device according to the flowchart shown in FIG. 4.

### DESCRIPTION OF EMBODIMENTS

Hereinafter, an embodiment of the present invention will be described with reference to the drawings.

### EMBODIMENT

### Configuration Example

### Hardware Configuration

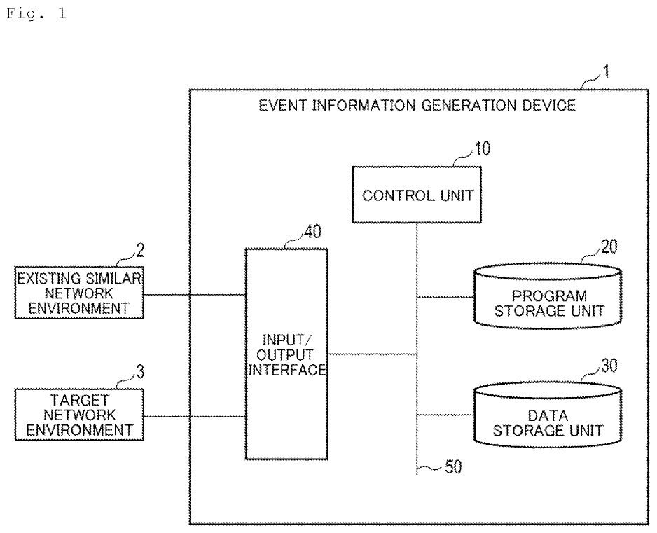

First, an example of a hardware configuration of an event information generation device 1 according to an embodiment will be described with reference to FIG. 1. FIG. 1 is a block diagram showing an example of a hardware configuration of the event information generation device 1 according to the embodiment. FIG. 1 also shows an existing similar network environment 2 and a target network environment 3 in addition to the event information generation device 1.

The event information generation device 1 is constituted by a computer such as a server computer or a personal computer. The event information generation device 1 includes a control unit 10, a program storage unit 20, a data storage unit 30, and an input/output interface 40. The control unit 10, the program storage unit 20, the data storage unit 30, and the input/output interface 40 are communicatively connected to each other via a bus 50.

The control unit 10 controls the event information generation device 1. The control unit 10 includes a hardware processor such as a central processing unit (CPU).

The input/output interface 40 is an interface that allows information to be transmitted and received between the existing similar network environment 2 and the target network environment 3. The input/output interface 40 is, for example, a wireless communication interface. The event information generation device 1 can perform at least reception of information from the existing similar network environment 2 and transmission and reception of information to and from the target network environment 3 via a network such as a LAN and the Internet.

The program storage unit 20 is configured, for example, by combining, as a storage medium, a non-volatile memory such as a hard disk drive (HDD) or a solid state drive (SSD) that can be written to and read from at any time and a non-volatile memory such as a read only memory (ROM). The program storage unit 20 stores an application program necessary for execution of various types of control processing of the event information generation device 1 in addition to middleware such as an operating system (OS).

The data storage unit 30 is configured, for example, by combining, as a storage medium, a non-volatile memory such as an HDD or an SSD that can be written to and read from at any time, and a volatile memory such as a random access memory (RAM). Data necessary for various types of control processing of the event information generation device 1 is temporarily stored.

The existing similar network environment 2 has a function of transmitting information to the event information generation device 1. That is, the existing similar network environment 2 can deliver information to the control unit 10 via the input/output interface 40.

The target network environment 3 has a function of receiving information from the event information generation device 1 and a function of transmitting information to the event information generation device 1. That is, the target network environment 3 can transmit and receive information to and from the control unit 10 via the input/output interface 40.

### Software Configuration

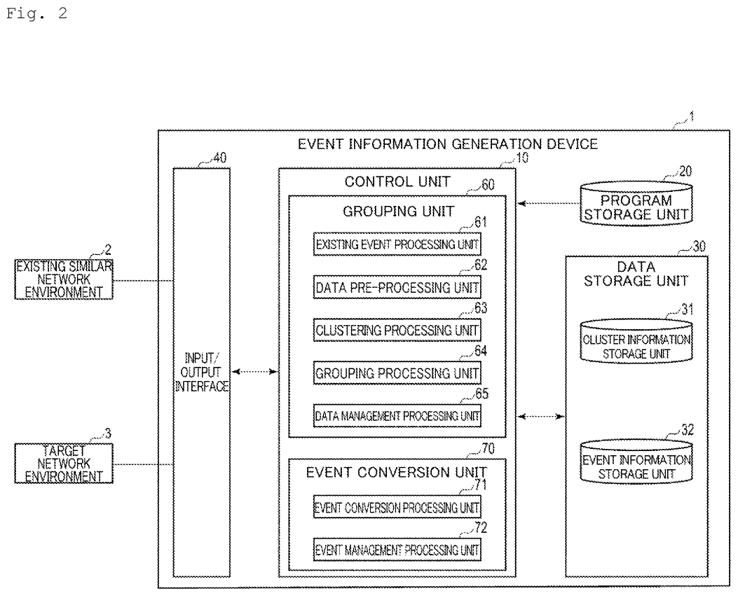

Next, an example of a software configuration of the event information generation device 1 according to the embodiment will be described with reference to FIG. 2. FIG. 2 is a block diagram showing a software configuration of the event information generation device 1 according to the embodiment. Also in FIG. 2, in addition to the event information generation device 1, the existing similar network environment 2 and the target network environment 3 are also shown.

First, prior to the description of the event information generation device 1, the existing similar network environment 2 and the target network environment 3 will be described.

The existing similar network environment 2 has a rule for failure location estimation in a network. The rule for failure location estimation is a reliable rule which has already been learned and verified. In the following description, the rule for failure location estimation which has already been learned and verified is simply referred to as a learned rule. The learned rule includes event information regarding an event related to a network failure. The event is an event causing the occurrence of a network failure or a sign of the occurrence. According to the learned rule, a failure location in the network is estimated based on the event information. In addition, the event information includes alarm information. The alarm information is information regarding the occurrence of a failure or a sign.

The target network environment 3 is, for example, a network environment in which a failure has occurred in the network or there is a sign of the occurrence of a failure, and is a network environment that requires rapid recovery work. The target network environment 3 also has a rule for failure location estimation, event information, and alarm information.

The existing similar network environment 2 is a network environment that is similar to the target network environment 3. For example, the existing similar network environment 2 is similar to the target network environment 3 in a network configuration, equipment of a network facility, or the like.

Next, the event information generation device 1 will be described. The event information generation device 1 is a device that generates event information to be applied to a rule for failure location estimation in the target network environment 3. As described with reference to FIG. 1, the event information generation device 1 includes the control unit 10, the program storage unit 20, the data storage unit 30, and the input/output interface 40.

The control unit 10 includes a grouping unit 60 and an event conversion unit 70. The grouping unit 60 performs clustering and grouping on alarm information of the existing similar network environment 2 and alarm information of the target network environment 3 to generate clusters having the same meaning although the shapes and formats thereof are not similar to each other. The event conversion unit 70 converts existing event information of the existing similar network environment 2 by using cluster information regarding the clusters generated by the grouping unit 60 to generate new event information to be applied to a rule of failure place estimation of the target network environment 3.

The data storage unit 30 includes a cluster information storage unit 31 and an event information storage unit 32. The cluster information storage unit 31 stores the cluster information generated by the grouping unit 60. The event information storage unit 32 stores the event information generated by the event conversion unit 70.

### Software configuration of Grouping Unit 60

The grouping unit 60 includes an existing event processing unit 61, a data pre-processing unit 62, a clustering processing unit 63, a grouping processing unit 64, and a data management processing unit 65.

The existing event processing unit 61 acquires existing event information of the learned rule from the existing similar network environment 2, and extracts alarm information for event determination from the acquired event information of the existing similar network environment 2.

The data pre-processing unit 62 acquires alarm information of the existing similar network environment 2 from the existing event processing unit 61, and acquires alarm information from the target network environment 3. The data pre-processing unit 62 pre-processes the acquired alarm information of the existing similar network environment 2 and the acquired alarm information of the target network environment 3. The pre-processing is processing for shaping the alarm information into data on which clustering and grouping can be performed easily. This pre-processing includes processing such as shaping of data (for example, data ranging, number change, or the like), morphological analysis, vectorization conversion (for example, one-hot vectorization conversion), and the like.

The clustering processing unit 63 acquires pre-processed alarm information of each of the existing similar network environment 2 and the target network environment 3 from the data pre-processing unit 62, and performs clustering on each pre-processed alarm information acquired, with respect to a shape and a format. That is, the clustering processing unit 63 collects data having similar shapes and formats in each pre-processed alarm information into the same cluster. For example, in clustering related to the shape and the format, similarity is determined using a method such as an Euclidean distance and a cosine distance from the viewpoint of classification. As a result, the clustering processing unit 63 generates clusters having similar shapes and formats with respect to the alarm information of each of the existing similar network environment 2 and the target network environment 3.

The grouping processing unit 64 acquires the pre-processed alarm information and cluster information from the clustering processing unit 63, and performs clustering on the pre-processed alarm information and the clusters with respect to the meaning based on the acquired information. As a result, the grouping processing unit 64 performs grouping of alarm information and clusters having dissimilar shapes and formats but having the same meaning. That is, the grouping processing unit 64 collects pieces of data having dissimilar shapes and formats but having the same meaning, among the pre-processed alarm information and clusters, into the same cluster. For example, in the grouping, similarity is determined by calculating a distance using a method such as a Ward method, a group average method, a shortest distance method, or the like from the viewpoint of hierarchical clustering. As a result, the grouping processing unit 64 generates clusters having similar shapes and formats but having the same meaning.

The data management processing unit 65 acquires cluster information regarding the cluster generated by the grouping processing unit 64, and stores and manages the acquired cluster information. The data management processing unit 65 stores the acquired cluster information in the cluster information storage unit 31 as one of processing of storage and management.

### Software Configuration of Event Conversion Unit 70

The event conversion unit 70 includes an event conversion processing unit 71 and an event management processing unit 72.

The event conversion processing unit 71 acquires existing event information from the existing similar network environment 2. The event conversion processing unit 71 also acquires cluster information from the cluster information storage unit 31. The event conversion processing unit 71 converts event information of the existing similar network environment 2 by using the acquired cluster information. For example, the event conversion processing unit 71 recognizes that the alarm information of the existing similar network environment 2 and the alarm information of the target network environment 3, which belong to the same cluster, are the same, and rewrites the event information of the existing similar network environment 2 on the basis of the recognition. The event conversion processing unit 71 generates the rewritten event information as new event information to be applied to a rule for failure location estimation of the target network environment 3.

The event management processing unit 72 acquires new event information from the event conversion processing unit 71, and stores and manages the acquired new event information. The event management processing unit 72 stores the new event information in the event information storage unit 32 as one of storage and management processes. The event management processing unit 72 also transmits the new event information to the target network environment 3.

### Realization Unit for Grouping Unit 60 and Event Conversion Unit 70

The processing units of the grouping unit 60, that is, the processing units of the existing event processing unit 61, the data pre-processing unit 62, the clustering processing unit 63, the grouping processing unit 64, and the data management processing unit 65, and the processing units of the event conversion unit 70, that is, the event conversion processing unit 71 and the event management processing unit 72, are realized by executing an event information generation program stored in the program storage unit 20 by a hardware processor included in the control unit 10.

### Operation Example

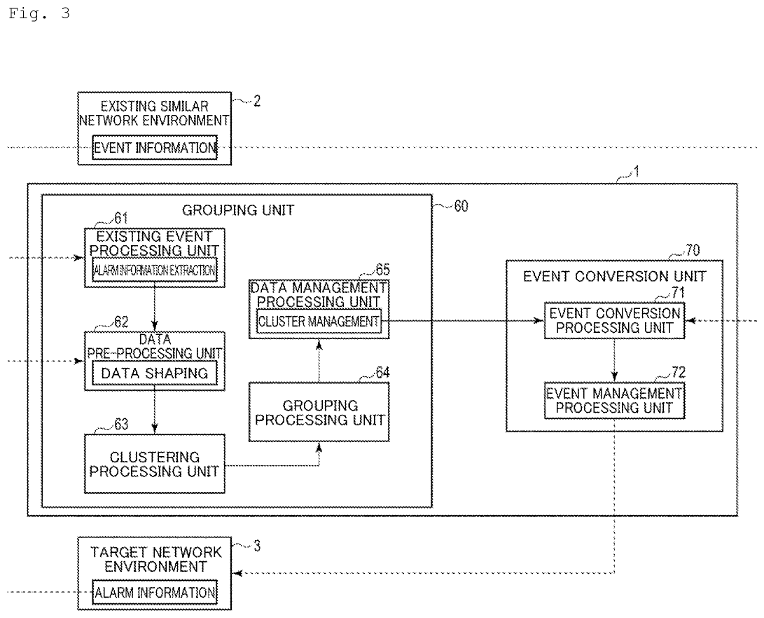

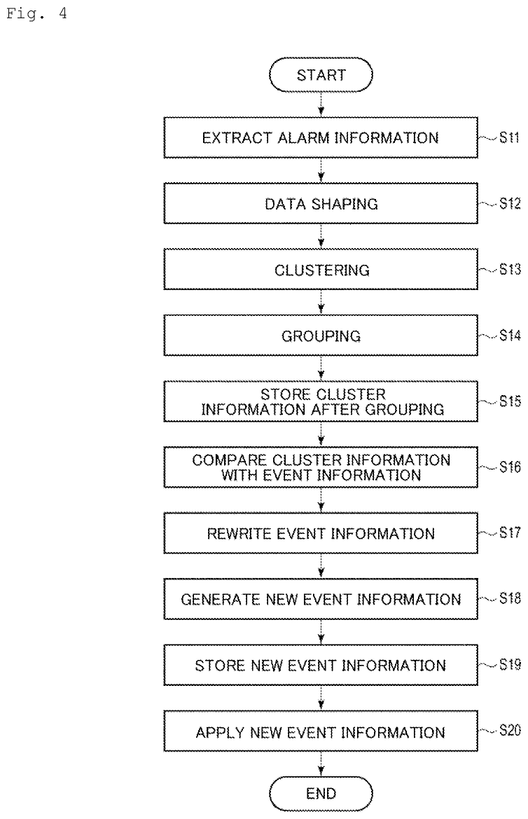

Next, an operation example of the event information generation device 1 configured as described above will be described with reference to FIGS. 3 and 4. FIG. 3 is a diagram showing a flow of data in the event information generation device 1 and a flow of information between the event information generation device 1, the existing similar network environment 2, and the target network environment 3.

An operation example to be described below is an example of operation performed by the control unit 10 of the event information generation device 1 under control of the grouping unit 60, the event conversion unit 70, the data storage unit 30, the existing similar network environment 2 and the target network environment 3.

The operation of the event information generation device 1 is started when a failure occurs in the target network environment 3. Here, it is assumed that the failure occurs in the following environment. The occurrence of the failure in the target network environment 3 is informed to the event information generation device 1 by a device, which is not shown in the drawing, or the like. The event information generation device 1 is given information of the existing similar network environment 2 corresponding to the target network environment 3. The event information generation device 1 starts an operation upon receiving a notification of occurrence of the failure in the target network environment 3.

In an operation to be described below, steps S11 to S15 are processes executed by the grouping unit 60, and steps S16 to S20 are processes executed by the event conversion unit 70.

### Operation of Grouping Unit 60

After the operation of the event information generation device 1 is started, first, the existing event processing unit 61 acquires existing event information of a learned rule from the existing similar network environment 2 in step S11. Next, the existing event processing unit 61 extracts alarm information for event determination from the acquired event information of the existing similar network environment 2. The existing event processing unit 61 transfers the extracted alarm information to the data pre-processing unit 62.

Next, in step S12, the data pre-processing unit 62 acquires the alarm information of the existing similar network environment 2 from the existing event processing unit 61. The data pre-processing unit 62 also acquires alarm information from the target network environment 3. Next, the data pre-processing unit 62 pre-processes the alarm information of the existing similar network environment 2 and the alarm information of the target network environment 3, and shapes the pre-processed information into data on which clustering and grouping can be performed easily. The data pre-processing unit 62 transfers the pre-processed alarm information to the clustering processing unit 63.

Subsequently, in step S13, the clustering processing unit 63 acquires the pre-processed alarm information of the existing similar network environment 2 and the target network environment 3 from the data pre-processing unit 62. Next, the clustering processing unit 63 performs clustering on each of the alarm information of the existing similar network environment 2 and the alarm information of the target network environment 3 with respect to a shape and a format. That is, the clustering processing unit 63 collects data having similar shapes and formats in each of the alarm information of the existing similar network environment 2 and the alarm information of the target network environment 3 into the same cluster. Thereby, the clustering processing unit 63 generates clusters having similar shapes and formats with respect to each of the alarm information of the existing similar network environment 2 and the alarm information of the target network environment 3. The clustering processing unit 63 transfers cluster information regarding the generated clusters to the grouping processing unit 64.

Next, in step S14, the grouping processing unit 64 acquires the pre-processed alarm information and cluster information from the clustering processing unit 63. Next, the grouping processing unit 64 performs second clustering on the pre-processed alarm information and the clusters with respect to the meaning based on the acquired information. That is, the grouping processing unit 64 collects data having the same meaning among the pre-processed alarm information and clusters into the same cluster. Thus, the grouping processing unit 64 performs grouping of alarm information and clusters having dissimilar shapes and formats but having the same meaning. As a result, the grouping processing unit 64 generates clusters after grouping which have dissimilar shapes and formats but have the same meaning. In this manner, the grouping processing unit 64 maps alarm information having the same meaning with respect to the existing similar network environment 2 and the target network environment 3 by clustering and grouping. The grouping processing unit 64 transfers cluster information regarding the grouped clusters to the data management processing unit 65.

Subsequently, in step S15, the data management processing unit 65 acquires cluster information from the grouping processing unit 64, and stores and manages the acquired cluster information. The data management processing unit 65 stores the cluster information regarding the grouped clusters in the cluster information storage unit 31 as one of storage and management processes.

### Operation of Event Conversion Unit 70

Next, in step S16, the event conversion processing unit 71 acquires existing event information of the learned rule from the existing similar network environment 2. The event conversion processing unit 71 also acquires cluster information regarding the grouped clusters from the cluster information storage unit 31. Next, the event conversion processing unit 71 compares the cluster information regarding the grouped clusters with the existing event information of the learned rule.

Subsequently, in step S17, the event conversion processing unit 71 rewrites the event information of the existing similar network environment 2 by using the cluster information. For example, the event conversion processing unit 71 recognizes that the alarm information of the existing similar network environment 2 and the alarm information 44 target network environment 3, which belong to clusters having dissimilar shapes and formats but having the same meaning, are the same, and rewrites the existing event information of the existing similar network environment 2 on the basis of the recognition. That is, the event conversion processing unit 71 rewrites the alarm information of the existing event information of the existing similar network environment 2 with the alarm information of the target network environment 3 belonging to clusters having dissimilar shape and formats but having the same meaning.

Next, in step S18, the event conversion processing unit 71 generates the event information rewritten in this manner as a new event to be applied to the target network environment 3. The event conversion processing unit 71 transfers the generated new event to the event management processing unit 72.

Subsequently, in step S19, the event management processing unit 72 acquires the new event information from the event conversion processing unit 71, and stores and manages the acquired new event information. The event management processing unit 72 stores the new event information in the event information storage unit 32 as one of storage and management processes.

Next, in step S20, the event management processing unit 72 transmits the new event information to the target network environment 3. The target network environment 3 applies the received new event information to a rule for failure location estimation.

### Transition of Learned Event Information in Operation Example of Event Information Generation Device 1

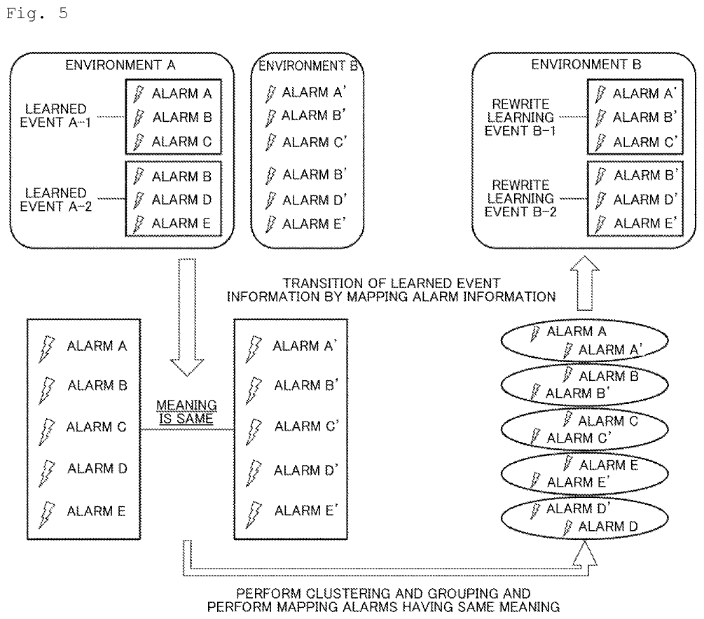

FIG. 5 schematically shows a transition of learned event information by mapping of alarm information in the operation example of the event information generation device 1 described above. In FIG. 5, an environment A represents the existing similar network environment 2, and an environment B represents the target network environment 3. In the example of FIG. 5, the environment A has two pieces of learned event information (events A-1 and A-2), the learned event information (event A-1) has alarm information (alarms A, B, and C), and the learned event information (event A-2) has alarm information (alarms B, D, and E). On the other hand, the environment B has alarm information (alarms A′, B′, and C′; alarms B′, D′, and E′) corresponding to the alarm information (alarms A, B, and C; alarms B, D, and E) of the environment A.

FIG. 5 shows the state of changes in event information and alarm information in processing to be described below.
(1) Clustering
   By clustering related to a shape and a format, the alarm information (alarms A, B, and C) of the learned event information A-1 and the alarm information (alarms B, D, and E) of the learned event information A-2 of the environment A are classified into five clusters (alarms A, B, C, D, and E), and the alarm information (alarms A′ B′, and C′, alarms B′, D′, and E′) of the environment B is classified into five clusters (alarms A′ B′, C′, D′, and E′) .
(2) Grouping
   By clustering and grouping related to a meaning, the clusters (alarms A, B, C, D, and E) of the environment A and the clusters (alarms A′ B′, C′, D′, and E′) of the environment B are grouped into five clusters (alarms A, A′; B, B′; C, C′; D, D′; E, E′) having dissimilar shapes and formats but having the same meaning.
(3) Rewriting and Application
   Recognizing that two pieces of alarm information belonging to each of the five clusters (alarms A, A′; B, B′; C, C′; D, D′; E, E′) are the same, the alarm information (alarms A, B, C, D, and E) is rewritten to the alarm information (alarms A′ B′, C′, D′, and E′). Furthermore, based on the rewritten alarm information (alarms A′, B′, C′, D′, and E′) , new event information (rewrite learning event B-1) having the alarm information (alarms A′, B′, and C′) and new event information (rewrite learning event B-2) having the alarm information (alarms B′, D′, and E′) are generated with respect to the environment B.

### Operations and Effects

According to the above-described embodiment, new event information to be applied to generation of a rule for failure location estimation of the target network environment 3 is generated using learned and reliable event information of a rule for failure location estimation of the existing similar network environment 2 similar to the target network environment 3 for the target network environment 3 in which a failure occurs in the network or there is a sign of the occurrence of the failure. The generation of the new event information by the event information generation device 1 does not require a determination result of the rule or determination of a failure coping result by a maintenance person.

Thereby, according to one embodiment, it is possible to generate a rule for failure location estimation including determination of an event and a coping method in a short period of time. That is, one embodiment provides an event information generation device, an event information generation method, and an event information generation program for generating event information for creating a rule for failure location estimation in a short period of time.

The present invention is not limited to the embodiments described above and can be modified in various ways without departing from the gist of the present invention at an execution stage. In addition, the embodiments may be combined as appropriate, and in such a case, combined effects can be achieved. In addition, the embodiments described above include various aspects of the invention, and the various aspects of the invention can be extracted by combinations selected from a plurality of disclosed constituent elements. For example, even when some of all the constituent elements disclosed in the embodiments are deleted, as long as the problems can be solved and the effects can be obtained, a configuration from which the constituent elements are deleted can be extracted as an aspect of the invention.

### REFERENCE SIGNS LIST

1 Event information generation unit
2 Existing similar network environment
3 Target network environment
10 Control unit
20 Program storage unit
30 Data storage unit
31 Cluster information storage unit
32 Event information storage unit
40 Input/output interface
50 Bus
60 Grouping unit
61 Existing event processing unit
62 Data pre-processing unit
63 Clustering processing unit
64 Grouping processing unit
65 Data management processing unit
70 Event conversion unit
71 Event conversion processing unit
72 Event management processing unit

1. An event information generation device that generates new event information to be applied to a rule for failure location estimation of a target network environment, the event information generation device comprising:
a grouping unit, including one or more processors, configured to perform clustering and grouping on alarm information of the target network environment and alarm information of an existing similar network environment similar to the target network environment to generate clusters having dissimilar shapes but having the same meaning; and
an event conversion unit, including one or more processors, configured to convert existing event information of the existing similar network environment by using the clusters having dissimilar shapes but having the same meaning, which are generated by the grouping unit, to generate the new event information.

2. The event information generation device according to claim 1, wherein
the grouping unit includes
an existing event processing unit, including one or more processors, configured to acquire existing event information of a learned rule for failure location estimation of the existing similar network environment, and extract alarm information of the existing similar network environment from the acquired existing event information,
a clustering processing unit, including one or more processors, configured to perform clustering on the alarm information of each of the existing similar network environment and the target network environment with respect to a shape to generate clusters having similar shapes, and
a grouping processing unit, including one or more processors, configured to perform clustering and grouping on the clusters having similar shapes, which are generated by the clustering processing unit, with respect to a meaning to generate clusters having dissimilar shapes but having the same meaning.

3. The even information generation device according to claim 2, wherein
the grouping unit further includes a data pre-processing unit, including one or more processors, configured to perform clustering and grouping on the alarm information of the existing similar network environment and the alarm information of the target network environment to shape the alarm information into data on which clustering and grouping can be performed by the clustering processing unit and the grouping processing unit.

4. The even information generation device according to claim 1, wherein
the event conversion unit is configured to acquire existing event information of the existing similar network environment, acquire the clusters having dissimilar shapes but having the same meaning, which are generated by the grouping unit, and convert the event information of the existing similar network environment by using the clusters having dissimilar shapes but having the same meaning.

5. The even information generation device according to claim 4, wherein
the event conversion unit is configured to recognize that the alarm information of the existing similar network environment and the alarm information of the target network environment, which belong to the clusters having dissimilar shapes but having the same meaning, are the same, rewrite the existing event information of the existing similar network environment, and generate the rewritten event information as the new event information.

6. The even information generation device according to claim 5, wherein
the event conversion unit is configured to rewrite the alarm information of the existing event information of the existing similar network environment with the alarm information of the target network environment belonging to the clusters having dissimilar shapes but having the same meaning.

7. An event information generation method of generating new event information to be applied to a rule for failure location estimation of a target network environment, the event information generation method comprising:
performing clustering and grouping on alarm information of the target network environment and alarm information of an existing similar network environment similar to the target network environment to generate clusters having dissimilar shapes but having the same meaning; and
converting existing event information of the existing similar network environment by using the generated clusters having dissimilar shapes but having the same meaning to generate the new event information.

8. A non-transitory computer-readable medium storing software comprising instructions executable by one or more computers which, upon such execution, cause the one or more computers to perform operations comprising:
performing clustering and grouping on alarm information of a target network environment and alarm information of an existing similar network environment similar to the target network environment to generate clusters having dissimilar shapes but having the same meaning; and
converting existing event information of the existing similar network environment by using the generated clusters having dissimilar shapes but having the same meaning to generate new event information.
